(19) United States
(12) Patent Application Publication
(10) Pub. No.: US 2023/0111785 A1
(43) Pub. Date: Apr. 13, 2023

(54) MACHINE-LEARNING TECHNIQUES TO GENERATE RECOMMENDATIONS FOR RISK MITIGATION

(71) Applicant: EQUIFAX INC., Atlanta, GA (US)

(72) Inventors: Allan JOSHUA, Atlanta, GA (US); Stephen MILLER, Atlanta, GA (US); Matthew TURNER, Cumming, GA (US); Lewis JORDAN, Atlanta, GA (US)

(21) Appl. No.: 17/905,150

(22) PCT Filed: Feb. 22, 2021
(86) PCT No.: PCT/US2021/019119

§ 371 Date: Aug. 26, 2022

Related U.S. Application Data
(60) Provisional application No. 62/981,718, filed on Feb. 26, 2020.
(60) Provisional application No. 63/038,486, filed on Jun. 12, 2020.

(51) Int. Cl. G06Q 40/03

(52) U.S. Cl. CPC G06Q 40/03

(57) ABSTRACT

Certain aspects involve an automated recommendation for risk mitigation. An entity assessment server, responsive to a request for a recommendation for achieving a target status of a risk indicator, accesses a set of input attributes for the entity and obtains a quantity of available resource useable for modifying at least resource-dependent attribute values of the entity. The entity assessment server generates a resource allocation plan for the available resource according to a first risk assessment model and updates the set of input attribute values based on the resource allocation plan. The entity assessment server further determines an updated value of the risk indicator for the entity based on the updated set of input attribute values according to a second risk assessment model and generates the recommendation to include the resource allocation plan of the available resource if the updated value of the risk indicator achieves the target status.

### Cross-Reference to Related Applications

This claims priority to U.S. Provisional Application No. 62/981,718, entitled “Automated Recommendation for Risk Mitigation,” filed on Feb. 26, 2020, and U.S. Provisional Application No. 63/038,486, entitled “Automated Recommendation for Risk Mitigation,” filed on Jun. 12, 2020, which are hereby incorporated in their entireties by this reference.

### TECHNICAL FIELD

The present disclosure relates generally to artificial intelligence. More specifically, but not by way of limitation, this disclosure relates to using machine learning or other modeling algorithms that emulate intelligence to generate recommended courses of actions.

### BACKGROUND

Machine-learning and other automated modeling processes can be used to perform one or more functions (e.g., acquiring, processing, analyzing, and understanding various inputs in order to produce an output that includes numerical or symbolic information). For instance, such techniques can involve using computer-implemented models and algorithms (e.g., a convolutional neural network, a support vector machine) to simulate human decision-making. In one example, a computer system programmed with a machine-learning model or another type of model can learn from training data and thereby perform a future task that involves circumstances or inputs similar to the training data. Such a computing system can be used, for example, to recognize certain individuals or objects in an image, to simulate or predict future actions by an entity based on a pattern of interactions to a given individual, etc.

### SUMMARY

Various embodiments of the present disclosure provide systems and methods for an automated recommendation for risk mitigation. In one example, an entity assessment server receives, from a user device, a request for a recommendation for achieving a target status of a risk indicator. The risk indicator is computed from input attribute values of an entity. The entity assessment server accesses a set of input attribute values for the entity. The set of input attribute values contain resource-dependent attribute values and non-resource-dependent attribute values. The entity assessment server further obtains a quantity of available resources useable for modifying at least the resource-dependent attribute values.

Continuing with this example, the entity assessment server generates a resource allocation plan for the available resource according to a risk assessment proxy model. The resource allocation plan specifies an allocation of the available resource to resource-dependent fields of at least one account associated with the entity. The entity assessment server updates the set of input attribute values. For instance, the entity assessment server updates at least the resource-dependent attribute values based on the resource allocation plan. The entity assessment server determines an updated value of the risk indicator for the entity based on the updated set of input attribute values according to a risk assessment model. The entity assessment server generates the recommendation to include the resource allocation plan of the available resource if the updated value of the risk indicator achieves the target status and transmits the recommendation to a remote computing device in response to the request for the recommendation.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE DRAWINGS

Features, embodiments, and advantages of the present disclosure are better understood when the following Detailed Description is read with reference to the accompanying drawings.

FIG. 1 is a block diagram depicting an example of a computing environment in which recommendations are generated to improve analytical or predictive outputs, such as risk indicator values, according to certain aspects of the present disclosure.

FIG. 2 is a flow chart depicting an example of a process for performing a resource allocation-based recommendation for risk mitigation, according to certain aspects of the present disclosure.

FIG. 3 is a flow chart depicting an example of a process for generating a recommendation for payment allocation to an entity's accounts to increase the risk score of the entity, according to certain aspects of the present disclosure.

FIG. 4 shows an example of the structure of a recurrent neural network that can be employed to predict the risk indicator according to certain aspects of the present disclosure.

FIG. 5 shows an example of attribute values used for different entities at different time points, according to certain aspects of the present disclosure.

FIG. 6 shows an example of training data used to train a risk assessment model, according to certain aspects of the present disclosure.

FIG. 7 is a block diagram depicting an example of a computing system suitable for implementing aspects of the techniques and technologies presented herein.

### DETAILED DESCRIPTION

Certain aspects and features of the present disclosure involve providing an automated recommendation for risk mitigation. In one example, an entity assessment server accesses attribute values associated with an entity for which the risk assessment is to be improved. The entity assessment server further obtains the amount of available resources for the entity to mitigate the risk. Using the attribute values and the amount of available resources, the entity assessment server determines a resource allocation plan for allocating the available resource to resource-dependent fields of various accounts associated with the entity. The determination can be performed by utilizing a risk assessment proxy model and maximizing a risk assessment score generated by the risk assessment proxy model. The entity assessment server further updates the attribute values based on the generated resource allocation plan and determines the risk indicator for the entity based on the updated attribute values according to a risk assessment model. The entity assessment server generates the risk mitigation recommendation to include the resource allocation plan if the determined risk indicator shows that the goal of the risk mitigation is achieved.

For instance, an entity assessment server may receive from a user device a request for a recommendation for improving the risk assessment score of an entity. The improvement can include increasing the current risk assessment score, which is computed from input attribute values of the entity to obtain a target risk assessment score that indicates a lower risk. To generate the recommendation, the entity assessment server accesses attribute data associated with the entity. The attribute data can include different attributes that describe the entity and are predictive of risk that is associated with the entity. These attributes can be classified into different types, such as time-dependent attributes whose values are determined or otherwise related to time, resource-dependent attributes whose values are related to the amount of resource (e.g., payment based attributes), and others.

Continuing with this example, the entity assessment server further obtains the amount of available resources (such as monetary resources) for the entity to mitigate the risk. Based on the amount of available resources, the entity assessment server can employ a risk assessment proxy model to determine a resource allocation plan for allocating the available resource to resource-dependent fields of accounts associated with the entity. The risk assessment proxy model approximates the risk assessment score of the entity using a simplified model. The simplified model allows the entity assessment server to generate an optimized resource allocation plan by maximizing the approximated risk assessment score under the constraints posed by the available resources. In examples, the risk assessment proxy model only uses resource-dependent attributes and does not consider non-resource-dependent attributes.

The entity assessment server updates attribute values by applying the available resource to resource-dependent attribute values according to the resource allocation plan. The updated attribute values reflect the attribute values after the resource allocation plan has been performed. Using the updated attribute values, the entity assessment server determines the risk indicator for the entity by employing a risk assessment model. The risk assessment model is configured to predict the risk indicator for an entity based on input attribute values associated with the entity, including both the resource-dependent attributes considered by the risk assessment proxy model and non-resource-dependent attributes. As such, the risk indicator generated by the risk assessment model is more accurate than that of the risk assessment proxy model.

The determined risk indicator can be used to predict if, after executing the resource allocation plan, the entity can achieve the goal of improvement. If not, the entity assessment server continues the above process for a subsequent time period to determine a resource allocation plan for the subsequent time period based on the available resource for the subsequent time period. If the goal of improvement can be achieved, the entity assessment server can further generate a risk mitigation recommendation to include the resource allocation plans for all the time periods that have been examined.

The generated recommendation can be utilized in various applications to improve the operations of one or more computing systems, industrial environments, or other systems impacted by a risk. As an illustrative example, the risk assessment score of an entity generated by a risk assessment model may indicate the likelihood of failure of one or more components in an industrial environment associated with the entity or indicate the risk of granting the entity access to an interactive computing environment. The generated recommendation can serve as instructions to the entity to reduce the likelihood of failure or to increase its chance of being granted access to the interactive computing environment.

As described herein, certain aspects provide improvements to risk assessment models for evaluating risks associated with an entity. Compared with existing risk assessment models that only provide a predicted risk assessment score associated with an entity without providing an explanation on how to achieve such a score, the technologies presented herein can automatically generate a recommendation of actions that can be used to improve an entity's risk assessment score, which can in turn facilitate improvements to the security or stability of a system associated with the entity.

Additional or alternative aspects can implement or apply rules of a particular type that improve existing technological processes involving risk assessment. For instance, to find the resource allocation plan to improve the risk associated with an entity from the current risk assessment status to the target assessment status, a particular set of rules are employed in the modeling process. This particular set of rules allows the target risk assessment status to be achieved, prevents an infeasible solution from being used, or facilitates a shorter path to be identified from the current risk assessment status to the target assessment status. Furthermore, additional rules can be introduced in the model to further increase the efficiency of the algorithm, such as rules for limiting the total allocated resource to be within the available resource for a certain period of time, rules for limiting the values of variables within their respective boundaries, or rules for enforcing the variables to be of their particular types (e.g., integer values). These particular rules enable the algorithm to be performed efficiently, such as by allowing the algorithm to be completed faster and requiring fewer computational resources without searching in the non-feasible solution space. Additionally or alternatively, these particular rules enable the algorithm to be performed more effectively, such as by finding a solution that is optimized or nearly optimized.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example

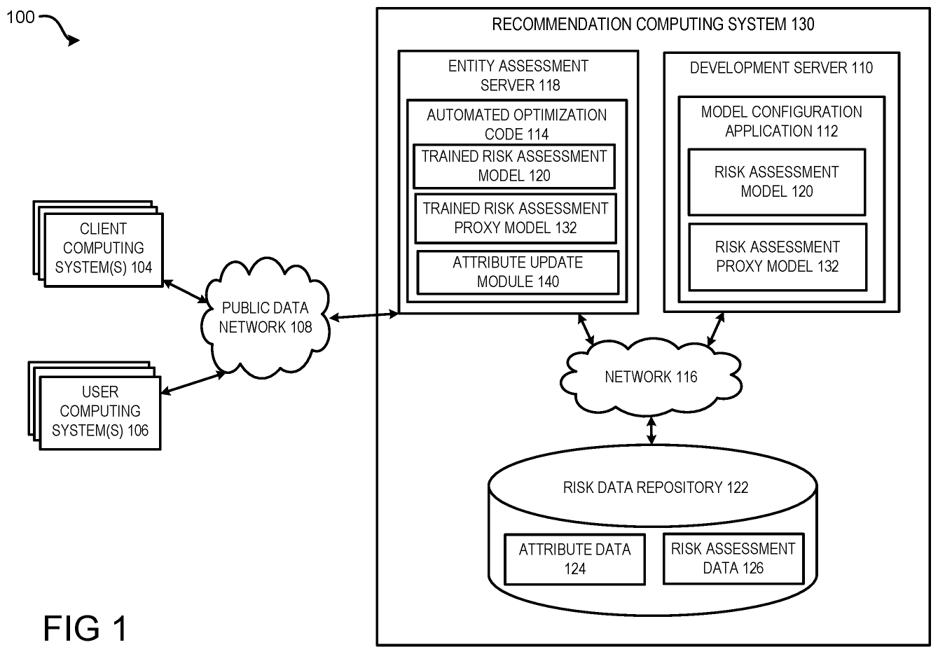

FIG. 1 is a block diagram depicting an example of an operating environment 100 in which a recommendation computing system 130 generates recommendations for improving risk indicator values or other analytical or predictive outputs. FIG. 1 depicts examples of hardware components of a recommendation computing system 130, according to some aspects. The recommendation computing system 130 is a specialized computing system that may be used for processing large amounts of data using a large number of computer processing cycles. The recommendation computing system 130 can include a development server 110 for building, training, or otherwise modifying a risk assessment model 120 and a risk assessment proxy model 132. The recommendation computing system 130 can further include an entity assessment server 118, which can execute automated optimization code 114 that utilizes the trained risk assessment model 120, the trained risk assessment proxy model 132, and attribute data from a risk data repository 122 to generate one or more recommendations with respect to one or more entities.

The development server 110 can include one or more processing devices that execute program code, such as a model configuration application 112. The program code is stored on a non-transitory computer-readable medium. The model configuration application 112 can execute one or more processes to train the risk assessment model 120 (e.g., a neural network, a decision tree, a linear regression model, a logistic regression model) for generating analytical or predictive outputs (e.g., risk indicators such as risk assessment score) based on one or more input variables, such as attributes that describe an entity. The model configuration application 112 can execute one or more processes to further train the risk assessment proxy model 132 based on the input variables.

In some embodiments, the model configuration application 112 can build and train a risk assessment model 120 for accurately predicting risk indicators (e.g., credit scores) associated with an entity accessing certain resources utilizing attribute data 124 and risk assessment data 126 associated with various entities. The attribute data 124 can include, for example, historical attribute data and current attribute data associated with these entities. The attribute data can include attribute vectors each containing values of different attributes that describe (or are otherwise associated with) an entity. An entity attribute can be any variable predictive of risk that is associated with an entity. An entity can be an individual, an organization, a device, a system, a component, and so on. Any suitable entity attribute that is authorized for use by an appropriate legal or regulatory framework may be used here.

Examples of entity attributes used for predicting the risk associated with an entity accessing online resources include, but are not limited to, variables or attributes indicating the demographic characteristics of the entity (e.g., name of the entity, the network or physical address of the company, the identification of the company, the revenue of the company), variables indicative of prior actions or transactions involving the entity (e.g., past requests of online resources submitted by the entity, the amount of online resource currently held by the entity), variables indicative of one or more behavioral traits of an entity (e.g., the timeliness of the entity releasing or returning the online resources), etc. Similarly, examples of predictor variables used for predicting the risk associated with an entity accessing services provided by a financial institute include, but are not limited to, variables or attributes indicative of one or more demographic characteristics of an entity (e.g., age, gender, income), variables or attributes indicative of prior or current actions or transactions involving the entity (e.g., information that can be obtained from credit files or records, financial records, consumer records, telco and utilities data, investment data, time-series credit data, deposit account data, or other data about the activities or characteristics of the entity), variables or attributes indicative of one or more behavioral traits of an entity, etc.

In some examples, these attributes can be classified into different types, such as time-dependent attributes, resource-dependent attributes, etc. Examples of time-dependent attributes include attributes whose values are determined or otherwise related to time, such as the number of resource requests in the past two months, the duration of time that the entity holds the online resources, the number of new online resources used by the entity, the number of past due resources, the number of inquiries within past three months, the age of the oldest account, the number of new accounts opened within past six months, the number of 30-day past due occurrences within six months on revolving trades, the number of bankcard accounts with major derogatory reported within past six months, the number of third party collections within past 12 months, etc. Examples of resource-dependent attributes include attributes whose values are related to the amount of resource (e.g., online computing resources such as virtual machines, online storage resources, and monetary resources) involved in transactions, such as the total amount of online storage currently used by the entity, the number of virtual machines used by the entity with over 90% of usage over the past five days, the total balance on multiple accounts of the entity, the number of accounts having a balance exceeding $1,000, and so on. As can be seen from these examples, although some attributes are classified as time-dependent attributes, they can also depend on resources (e.g., the number of virtual machines used by the entity with over 90% of usage over the past five days, the number of 30-days past due occurrences within six months depending on the payment to determine the past due status). Likewise, some resource-dependent resources may also depend on time. In other words, the time-dependent attributes and resource-dependent attributes are not mutually exclusive to each other and some attributes may depend on both time and resources.

An attribute vector can be a vector with attribute data that is gathered from interactions with one or more client computing systems 104, one or more user computing systems 106, or both. The risk assessment data 126 can include, for example, data identifying a certain outcome associated with the attribute data 124 (e.g., payment status over time on an approved financial product based on the attribute data 124; approval or disapproval for a product or a service, such as online computing service, online storage service, a credit card, a loan, based on the attribute data 124), data identifying a risk assessment associated with the attribute data 124 (e.g., a credit score), and so on. Attribute data 124 and associated risk assessment data 126 can be used by the model configuration application 112 to build, train, or otherwise modify a risk assessment model 120.

Attribute data 124 and associated risk assessment data 126 can also be used by the model configuration application 112 to build, train, or otherwise modify a risk assessment proxy model 132. In some examples, the risk assessment proxy model 132 includes a simplified model that approximates the risk assessment data 126 using the attribute data 124. For example, the risk assessment proxy model 132 can model the outcome described in the risk assessment data 126 as a linear combination of the associated attribute data 124 or a subset thereof. In some examples, only resource-dependent attributes are utilized in the risk assessment proxy model 132.

The attribute data 124 and associated risk assessment data 126 can be stored separately or together in one or more network-attached storage units on which various repositories, databases, or other structures are stored. Examples of these data structures are the risk data repository 122.

Network-attached storage units may store a variety of different types of data organized in a variety of different ways and from a variety of different sources. For example, the network-attached storage unit may include storage other than primary storage located within the development server 110 that is directly accessible by processors located therein. In some aspects, the network-attached storage unit may include secondary, tertiary, or auxiliary storage, such as large hard drives, servers, virtual memory, among other types. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape or an optical storage media such as compact disk or digital versatile disk, flash memory, memory or memory devices.

The entity assessment server 118 can include one or more processing devices that execute program code, such as automated optimization code 114. The program code is stored on a non-transitory computer-readable medium. The automated optimization code 114 can be configured to optimize the trained risk assessment proxy model 132 to determine a recommendation with respect to the risk assessment (e.g., a recommended set of actions for improving the risk assessment outcome or the risk indicator value). For example, the risk assessment outcome or the risk indicator can be a risk assessment score or an indication of approval or disapproval for a certain product or service. The automated optimization code 114 can further utilize the risk assessment model 120 trained by the model configuration application 112 to generate based on input attribute data a more accurate estimation of the risk assessment outcome or the risk indicator value. This more accurate estimation can be utilized to determine whether the recommendation is effective in improving the risk assessment outcome. If the recommendation for an entity involves multiple time periods, the entity assessment server 118 can also employ an attribute update module 140 to update attributes associated with the entity for each time period so the predicted risk assessment outcome for each time period is based on the correct attribute values.

Furthermore, the recommendation computing system 130 can communicate with various other computing systems, such as client computing systems 104. For example, client computing systems 104 or the user computing systems 106 may send risk assessment queries, recommendation requests, or both to the entity assessment server 118 for risk assessment, or may send signals to the entity assessment server 118 that control or otherwise influence different aspects of the recommendation computing system 130. The client computing systems 104 may also interact with the user computing systems 106 via one or more public data networks 108 to facilitate electronic transactions between users of the user computing systems 106 and interactive computing environments provided by the client computing systems 104.

Each client computing system 104 may include one or more third-party devices, such as individual servers or groups of servers operating in a distributed manner. A client computing system 104 can include any computing device or group of computing devices operated by a seller, lender, or other providers of products or services. The client computing system 104 can include one or more server devices. The one or more server devices can include or can otherwise access one or more non-transitory computer-readable media. The client computing system 104 can also execute instructions that provide an interactive computing environment accessible to user computing systems 106. Examples of the interactive computing environment include a mobile application specific to a particular client computing system 104, a web-based application accessible via a mobile device, etc. The executable instructions are stored in one or more non-transitory computer-readable media.

The client computing system 104 can further include one or more processing devices that are capable of providing the interactive computing environment to perform operations described herein. The interactive computing environment can include executable instructions stored in one or more non-transitory computer-readable media. The instructions providing the interactive computing environment can configure one or more processing devices to perform operations described herein. In some aspects, the executable instructions for the interactive computing environment can include instructions that provide one or more graphical interfaces. The graphical interfaces are used by a user computing system 106 to access various functions of the interactive computing environment. For instance, the interactive computing environment may transmit data to and receive data from a user computing system 106 to shift between different states of the interactive computing environment, where the different states allow one or more electronics transactions between the user computing system 106 and the client computing system 104 to be performed.

A user computing system 106 can include any computing device or other communication device operated by a user, such as a consumer or a customer. The user computing system 106 can include one or more computing devices, such as laptops, smart phones, and other personal computing devices. A user computing system 106 can include executable instructions stored in one or more non-transitory computer-readable media. The user computing system 106 can also include one or more processing devices that are capable of executing program code to perform operations described herein. In various examples, the user computing system 106 can allow a user to access certain online services from a client computing system 104, to engage in mobile commerce with a client computing system 104, to obtain controlled access to electronic content hosted by the client computing system 104, etc.

For instance, the user can use the user computing system 106 to engage in an electronic transaction with a client computing system 104 via an interactive computing environment. An electronic transaction between the user computing system 106 and the client computing system 104 can include, for example, the user computing system 106 being used to request online storage resources managed by the client computing system 104, acquire cloud computing resources (e.g., virtual machine instances), and so on. An electronic transaction between the user computing system 106 and the client computing system 104 can also include, for example, querying a set of sensitive or other controlled data, accessing online financial services provided via the interactive computing environment, submitting an online credit card application or other digital application to the client computing system 104 via the interactive computing environment, or operating an electronic tool within an interactive computing environment hosted by the client computing system (e.g., a content-modification feature, an application-processing feature).

In some aspects, an interactive computing environment implemented through a client computing system 104 can be used to provide access to various online functions. As a simplified example, a website or other interactive computing environment provided by an online resource provider can include electronic functions for requesting computing resources, online storage resources, network resources, database resources, or other types of resources. In another example, a website or other interactive computing environment provided by a financial institution can include electronic functions for obtaining one or more financial services, such as loan application and management tools, credit card application and transaction management workflows, electronic fund transfers, etc. A user computing system 106 can be used to request access to the interactive computing environment provided by the client computing system 104, which can selectively grant or deny access to various electronic functions. Based on the request, the client computing system 104 can collect data associated with the user and determine whether to grant the access request of the user computing system 106 to certain features of the interactive computing environment. The determination can be made by communicating with the entity assessment server 118 for risk assessment or through an internal risk assessment model.

For example, a risk indicator can be generated to indicate the associated risk based on the collected data. The predicted risk indicator can be utilized by the service provider (e.g., the online resource provider or the financial service provider) to determine the risk associated with the entity accessing the service provided by the service provider, thereby granting or denying access by the entity to an interactive computing environment implementing the service. For example, if the service provider determines that the predicted risk indicator is lower than a threshold risk indicator value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 associated with the service provider can also allocate resources to the user and provide a dedicated web address for the allocated resources to the user computing system 106, for example, by adding it in the access permission. With the obtained access credentials and/or the dedicated web address, the user computing system 106 can establish a secure network connection to the computing environment hosted by the client computing system 104 and access the resources via invoking API calls, web service calls, HTTP requests, or other proper mechanisms.

If the client computing system 104 determines to deny the access request, the client computing system 104 or the user computing system 106 can communicate with the entity assessment server 118 to determine recommendations for the user to improve the risk assessment so that the access request can be approved.

Each communication within the operating environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The numbers of devices depicted in FIG. 1 are provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the development server 110 and the entity assessment server 118, may be instead implemented in a signal device or system.

### Examples of Operations Involving Recommendations Based on Resource Allocation

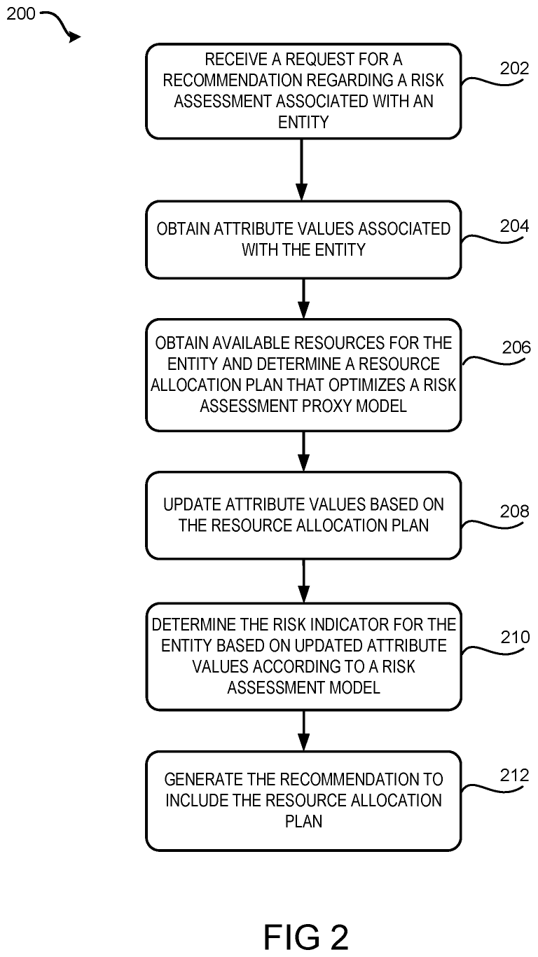

FIGS. 2-6 depict various operations that involve generating recommendations based on resource allocation. For illustrative purposes, FIGS. 2-6 describe these operations with respect to examples such as credit scores, monetary resource allocation (such as payment allocation), and associated attributes. But, in various aspects, the operations described herein can be used to generate recommendations for modifying the actions of other aspects of the entities. As one example, the recommendation computing system 130 can generate recommendations for reducing the risk associated with accessing online computing resources as discussed above with respect to FIG. 1. In another example, the recommendation computing system 130 can generate recommendations for reducing the likelihood of failure of one or more components in an industrial environment, where an entity can be a machine or a set of machines and entity attributes can include maintenance of the machine, frequency of use, etc. As another example, the recommendation computing system 130 can generate recommendations for reducing the likelihood of failure of a breach or intrusion into a secure computing environment, where an entity can be the computing environment and entity attributes can include various factors indicative of the security of the computing environment.

In an illustrative example involving credit scoring or credit product approval, the recommendation computing system 130 can be used to generate recommendations with respect to credit risk indicators, such as the credit risk score. A credit risk score can be an indicator of financial health. Even though there are many different credit risk scores for different applications, they are each a measure of risk on a financial product and a proxy indication of financial health. Therefore, it can be useful and beneficial to consumers to learn more about the profiles of consumers that are assessed as a safe and sound financial risk. In addition, providing recommendations for a personalized action plan to a consumer to reach a certain risk level profile or to obtain approval for a certain financial product adds transparency and understanding to credit risk models.

For instance, a consumer may wish to reach a given credit score threshold or an approval level. This threshold or the approval letter may be a threshold or a level that qualifies for a better pricing offer or some other minimum credit risk score required for the consumer to complete a certain type of transaction. In the U.S., the regulation requires that the “key factors” that impact a credit score must be returned with the credit score. These factors are the items on the credit report that have the largest negative impact on the score. In many instances, these key factors are not immediately actionable to the consumer. However, the recommendation computing system 130 can compute a recommendation that describes or otherwise indicates a set of one or more actions to be taken by a consumer or other user to reach the credit score threshold or the approval level.

The recommendation can achieve a desired purpose if the set of one or more actions included in the recommendation is actionable and feasible. Operations described herein can be used to provide a set of feasible actions for a given entity, which can reduce or avoid disadvantages associated with trial-and-error risk-assessment simulators or generic advice based on an analysis of a profile of entity attributes. These operations can include allocating payments under the budget constraints to maximize or improve the credit risk score or the chances of obtaining approval for a credit product, especially those modeled by machine-learning algorithms capturing non-linearities and interactions. In some examples, a sequence of payment actions is generated to provide the consumer with step-by-step instructions to improve the credit risk score or the chances of obtaining the approval.

FIG. 2 is a flow chart depicting an example of a process 200 for performing a resource allocation-based recommendation for risk mitigation. For illustrative purposes, the process 200 is described with reference to implementations described with respect to various examples depicted in FIG. 1. Other implementations, however, are possible. The operations in FIG. 2 are implemented in program code that is executed by one or more computing devices, such as the automated optimization code 114 that is executed by an entity assessment server 118.

At block 202, the process 200 involves receiving a request for a recommendation regarding a risk assessment. The entity assessment server 118 can execute the automated optimization code 114 and thereby perform one or more operations that implement block 202. For example, the entity assessment server 118 can establish or join a communication session with a remote computing device, such as a client computing system 104 or a user computing system 106. The entity assessment server 118 can receive a request for a recommendation regarding a risk assessment. In some aspects, the request includes data that identifies or can be used to identify a particular entity. Examples of this data include the name of an entity, an identifier of a record in which data about the entity is stored, etc. The request can indicate different types of recommendations. In various examples, the request can indicate that a recommendation for achieving a goal or a target status associated with the risk assessment of the entity is desired. The goal or target status can include, for example, increasing a risk assessment score (e.g., a credit score indicating financial health), obtaining approval for a product or service, decreasing a risk assessment score (e.g., a likelihood of a machine failure, a default, a breach), avoiding a change in a risk assessment score (e.g., actions to avoid in order to maintain a current health or system performance), and so on.

At block 204, the process 200 involves obtaining attribute values associated with the entity specified or otherwise indicated in the request. The entity assessment server 118 can execute the automated optimization code 114 and thereby perform one or more operations that implement block 204. For example, the entity assessment server 118 can access the attribute data associated with the entity from the risk data repository 122, or it can retrieve the relevant data from the risk data repository 122 and derive the attribute data from the retrieved data. For example, the attribute data associated with the entity may be pre-computed and stored as the attribute data 124 in the risk data repository 122. As new data are received, the recommendation computing system 130 may update the attribute data 124 from time to time. In another example, raw data recording the transactions associated with the entities are stored in the risk data repository 122. When the attribute values associated with an entity is needed, the entity assessment server 118 accesses the transaction data for the entity to derive the relevant attribute values. In examples where credit scoring and approvals are involved, the attribute values for an entity may include attributes for various accounts associated with the entity, such as the balances, the number of days past due, the minimum payments, and so on. The accounts could be a mortgage, a credit card, a personal loan, an auto loan, etc.

At block 206, process 200 involves obtaining the amount of available resources for the entity to mitigate the risk. In one example, the resource is a monetary resource that can be used to reduce the balances of the accounts associated with the entity thereby improving the risk assessment result of the entity. Based on the amount of available resources, the entity assessment server 118 can determine a resource allocation plan for allocating the available resources to resource-dependent fields of various accounts associated with the entity by employing a trained risk assessment proxy model 132. The risk assessment proxy model 132 approximates a risk assessment score or other quantitative aspects of the risk assessment using a simplified model so that an optimized resource allocation plan can be obtained by maximizing the approximated risk assessment score. In some examples, the risk assessment proxy model 132 approximates the risk assessment score based on various attributes associated with the entity. In other examples, the risk assessment proxy model 132 only uses resource-dependent attributes and does not consider non-resource-dependent attributes. In this way, the risk assessment proxy model 132 can be simplified to reduce computational complexity while still allowing the resource allocation plan to be calculated and optimized with high accuracy. In some implementations, the risk assessment proxy model 132 is built as a linear function of the resource-dependent attributes. The automated optimization code 114 is configured to optimize the linear function (e.g., maximize the risk assessment score) under various constraints related to resource allocation, such as the total amount of allocated resources is no more than the available resource, the allocated resource for each account is between a lower bound and an upper bound, and so on.

At block 208, the process 200 involves updating attribute values based on the resource allocation plan obtained at block 206. The updated attribute values reflect the attribute values after the resource allocation plan has been performed. The resource-dependent attribute values can be updated by applying the available resource based on the resource allocation plan. For example, if the resource allocation plan indicates that x amount of monetary resource should be allocated to a specific account of the entity, then the balance value associated with that specific account is updated by reducing the balance by x. The balance attribute determined based on the balance values of the accounts associated with the user is updated to reflect the change. The entity assessment server 118 further updates non-resource-dependent attributes. For example, non-resource-dependent attributes might include time-dependent attributes. The time-dependent attributes are updated based on the time duration of the resource allocation plan. If the resource allocation plan is for one month, then the time-dependent attributes are updated to reflect the attribute values at the end of the one month.

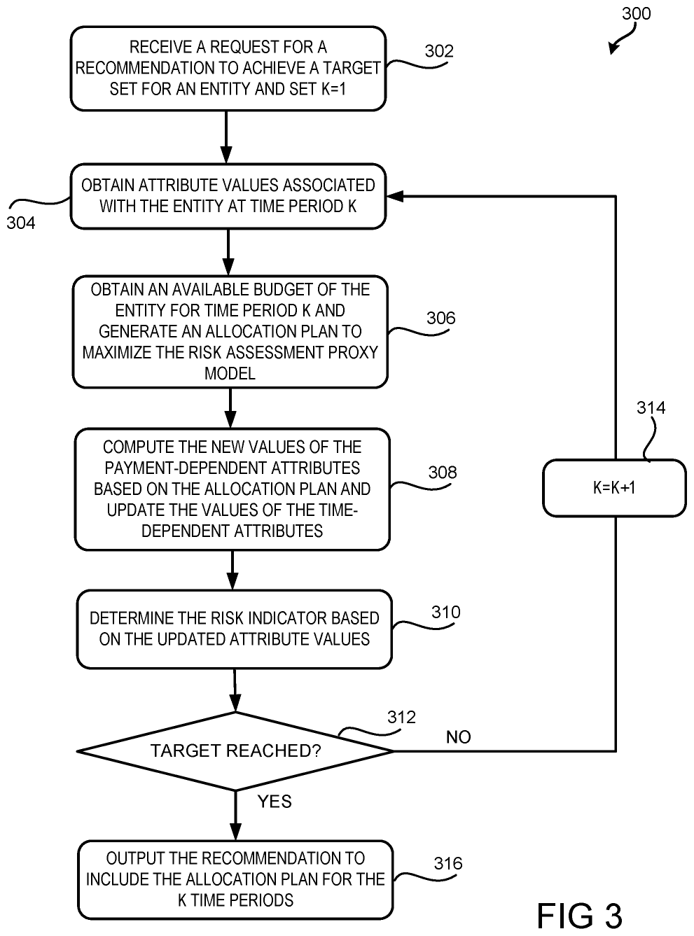

In some cases, attributes can depend on both payment and time. Payment will affect the current rating status, the payment status grid, past due amounts, balance, and other potential account level fields. These attributes are updated before other updated attribute values are computed. For example, the attribute “Number of 30 Days Past Due Occurrences within 24 Months” requires a value to fall off of the payment status grid and a new value to be added for every trade on the file. In some implementations, all account level fields on the credit file can be written as a function of payment. A method to update these fields can be performed before attributes are computed by aggregating across relevant fields. Additional details for updating the attributes based on the resource allocation plan are provided below with respect to FIG. 3.

At block 210, the process 200 involves determining the risk indicator for the entity based on the updated attribute values. In some examples, the risk indicator is determined based on the risk assessment model 120. As discussed above with respect to FIG. 1, the risk assessment model 120 can predict or generate the risk indicator for an entity based on input attribute values associated with the entity, including both the resource-dependent attributes considered by the risk assessment proxy model 132 and non-resource-dependent attributes. The risk assessment model 120 can be built using any type of modeling tools, such as the neural network, recurrent neural network (RNN), linear regression model, logistic regression model, or any combination thereof. In some examples, the risk assessment model 120 is the actual model used to determine the risk indicator of an entity. In these cases, the risk indicator generated at block 210 is the actual value, rather than a predicted value, of the risk indicator if the allocation plan was executed. Additional details about the risk assessment model 120 are described below with respect to FIGS. 3-6. The determined risk indicator can be used to predict if, after executing the resource allocation plan, the entity can achieve the goal, such as reaching the desired credit score or obtaining the approval for the product, and so on.

At block 212, the recommendation computing system 130 generates a recommendation to include the resource allocation plan if the risk indicator determined at block 210 shows that the goal or target status specified in the request can be achieved. The recommendation computing system 130 can transmit the recommendation to the client computing system 104 or the user computing system 106 depending on which system requested the recommendation. The recommendation can cause the entity to deploy the available resources to the accounts associated with the entity as specified in the allocation plan.

In some aspects of the present disclosure, one or more operations shown in FIG. 2 may be omitted or performed in a different order. For example, block 210 can be omitted and the resource allocation plan generated at block 206 can be used to generate the recommendation without executing the risk assessment model on the updated attribute values. Similarly, additional operations not shown in FIG. 2 may be performed.

FIG. 3 is a flow chart depicting an example of a process 300 for generating a recommendation for monetary resource allocation (i.e., payment allocation) to an entity's accounts in order to increase the credit score of the entity and to obtain the approval for a credit product or service. For illustrative purposes, the process 300 is described with reference to implementations described with respect to various examples depicted in FIG. 1. Other implementations, however, are possible. The operations in FIG. 3 are implemented in program code that is executed by one or more computing devices, such as the automated optimization code 114 that is executed by an entity assessment server 118. In some aspects of the present disclosure, one or more operations shown in FIG. 3 may be omitted or performed in a different order. Similarly, additional operations not shown in FIG. 3 may be performed.

At block 302, the process 300 involves receiving a request for a recommendation to achieve a goal or a target risk indicator value set for an entity. In some examples, the target risk indicator value includes a value indicating approval for a credit product or service, such as a credit card or a loan. The time period counter K is set to 1 at the beginning of the recommendation generation process.

At block 304, the process 300 involves obtaining attribute values associated with the entity at time period K. As discussed above with respect to block 204 of FIG. 2, the entity assessment server 118 can access the attribute data associated with the entity from the risk data repository 122 or can retrieve the relevant data from the risk data repository 122 and derive the attribute data from the retrieved data. In some examples, the attribute values are obtained to include the input attribute values used by the risk assessment model 120 and the risk assessment proxy model 132. The attribute values are calculated or otherwise determined with respect to the current time period K. For example, the attributes may include the total amount of outstanding balance, the number of accounts with a balance higher than $1,000, the number of new accounts opened within past six months, and so on. In some examples, the attribute values obtained at block 304 include values for resource-dependent attributes (i.e., payment-dependent attributes in this example), time-dependent attributes, or other types of attributes. It should be noted that if the operations performed in the current time period K utilize historical attribute values, the entity assessment server 118 also obtains the historical attribute values for the entity at block 304.

At block 306, the process 300 involves obtaining the available budget of the entity for the current time period, i.e. time period K, and generating an allocation plan to maximize the risk assessment proxy model 132. The resource allocation plan specifies an allocation of the available budget to payment-dependent fields of at least one account associated with the entity. In some examples, an optimization problem is formulated that maximizes the risk assessment proxy model 132 under the payment-related constraints and the automated optimization code 114 is configured to solve this optimization problem. The risk assessment proxy model 132 is formulated as a linear model over the input attributes. In further examples, the input attributes of the risk assessment proxy model 132 are payment-dependent attributes.

For illustration purposes, assume there are two payment-dependent input attributes: the total balance on all accounts and the number of accounts having a balance over $1,000. The total balance on all accounts can be determined as the sum of the balance on each account of the entity. Denote the number of accounts of the entity as nᵢ, and the balance on an account j as balⱼ. The total balance associated with the entity is thus Σⱼ₌₁ⁿ^{ᵢ}balⱼ and the number of accounts having a balance over $1,000 is Σⱼ₌₁ⁿ^{ᵢ}I(balⱼ>1000). Here, I(q) is an indicator function of an event q. I(q) equals 1 if the event q occurs and equals 0 if the event q does not happen. In this example, the risk assessment proxy model 132 estimates the credit score for the entity as a linear combination of these two attribute values:

S=β₀+β₁Σⱼ₌₁ⁿ^{ᵢ}balⱼ+β₂Σⱼ₌₁ⁿ^{ᵢ}I(balⱼ>1000) (1)

Denoting the available budget for time period K as C, and a payment allocation vector as p=[p₁, p₂, p₃, . . . , pₙ_{ᵢ}]^{T}, the new balance for account j becomes balⱼ−pⱼ. The new estimated credit score thus becomes:

S=β₀+β₁Σⱼ₌₁ⁿ^{ᵢ}(balⱼ−pⱼ)+β₂Σⱼ₌₁ⁿ^{ᵢ}I(balⱼ−pⱼ>1000) (2)

In order to obtain the optimized payment allocation vector, the automated optimization code 114 is further configured to solve the following optimization problem:

$$min : - S = - {β}_{0} - {β}_{1} {\sum }_{j = 1}^{{n}_{i}} ( b a {l}_{j} - {p}_{j} ) - {β}_{2} {\sum }_{j = 1}^{{n}_{i}} I ( ba {l}_{j} - {p}_{j} > 10 \; 00 ) \qquad ( 3 )$$

$$subject to : A \cdot p {=}^{def} [ \begin{matrix}1 & 0 & … & 0 \\ 0 & 1 & … & 0 \\ ⋮ & ⋮ & ⋱ & 0 \\ 0 & 0 & … & 1 \\ 1 & 1 & … & 1\end{matrix} ] [ \begin{matrix}{p}_{1} \\ {p}_{2} \\ ⋮ \\ {p}_{{n}_{i}}\end{matrix} ] \leq [ \begin{matrix}{bal}_{1} \\ {bal}_{2} \\ ⋮ \\ {bal}_{{n}_{i}} \\ {C}_{1}\end{matrix} ] {=}^{def} b$$

$$lb {=}^{def} {[ \begin{matrix}{L}_{1} & {L}_{2} & … & {L}_{{n}_{i}}\end{matrix} ]}^{T} \leq {[ \begin{matrix}{p}_{1} & {p}_{2} & … & {p}_{{n}_{i}}\end{matrix} ]}^{T} \leq {[ \begin{matrix}{U}_{1} & {U}_{2} & … & {U}_{{n}_{i}}\end{matrix} ]}^{T} {=}^{def} ub$$

In the above optimization problem, the first constraint requires that the allocated payment for each account does not exceed the respective account balance and that the total payment should be less than or equal to the available budget C₁. The second constraint limits each payment allocation value pᵢ to be between a respective lower bound Lᵢ and upper bound Uᵢ. The lower bound can be set according to, for example, zero or the minimum payment for a corresponding account. The upper bound can be set to be the current balance or other value determined by the entity assessment server 118 or the requesting party.

The optimization problem in Eq. (3) has integer-valued inputs, such as the indicator function I(⋅). To solve the optimization problem with integer-valued inputs, “slack variables” that are treated as continuous can be introduced into the optimization problem. These slack variables introduce new constraints that correspond to the events that were being counted. An example of the events can include “does an account have a balance greater than 1000.” Each slack variable introduces two new constraints into the A matrix, two new constraints into the lb and ub vectors, and the optimization problem in Eq. (3) becomes:

$$min : - S = - {β}_{0} - {β}_{1} {\sum }_{j = 1}^{{n}_{i}} ( b a {l}_{j} - {p}_{j} ) - {β}_{2} {\sum }_{j = 1}^{{n}_{i}} {y}_{j} \qquad ( 4 )$$

$$subject to : A \cdot x {=}^{def} [ \text{} \begin{matrix}1 & 0 & … & 0 & 1001 & 0 & … & 0 \\ 0 & 1 & … & 0 & 0 & 1001 & … & 0 \\ ⋮ & ⋮ & ⋱ & ⋮ & ⋮ & ⋮ & ⋱ & ⋮ \\ 0 & 0 & … & 1 & 0 & 0 & … & 1001 \\ - 1 & 0 & … & 0 & 1001 - {bal}_{1} & 0 & … & 0 \\ 0 & - 1 & … & 0 & 0 & 1001 - {bal}_{2} & … & 0 \\ ⋮ & ⋮ & ⋱ & ⋮ & ⋮ & ⋮ & ⋱ & ⋮ \\ 0 & 0 & … & - 1 & 0 & 0 & … & 1001 - {bal}_{{n}_{i}} \\ 1 & 1 & … & 1 & 0 & 0 & … & 0\end{matrix} ] [ \begin{matrix}{p}_{1} \\ {p}_{2} \\ ⋮ \\ {p}_{{n}_{i}} \\ {y}_{1} \\ {y}_{2} \\ ⋮ \\ {y}_{{n}_{i}}\end{matrix} ] \leq [ \begin{matrix}{bal}_{1} \\ {bal}_{2} \\ ⋮ \\ {bal}_{{n}_{i}} \\ 1001 - {bal}_{1} \\ 1001 - {bal}_{2} \\ ⋮ \\ 1001 - {bal}_{{n}_{i}} \\ {C}_{1}\end{matrix} ]$$

$$lb {=}^{def} {[ \begin{matrix}{L}_{1} & {L}_{2} & … & {L}_{{n}_{i}} & 0 & 0 & … & 0\end{matrix} ]}^{T} \leq {[ \begin{matrix}{p}_{1} & {p}_{2} & … & {p}_{{n}_{i}} & {y}_{1} & {y}_{2} & … & {y}_{{n}_{i}}\end{matrix} ]}^{T} \leq {[ \begin{matrix}{U}_{1} & {U}_{2} & … & {U}_{{n}_{i}} & 1 & 1 & … & 1\end{matrix} ]}^{T} {=}^{def} ub$$

The lower bounds and the upper bounds of the payment allocations pᵢ remain the same. The lower and upper bounds 0 and 1 of yⱼ reflect that this slack variable is a continuous approximation of the indicator function I(.).

To formulate the additional constraints specified in Eq. (4) that the slack variables must satisfy, there are four cases to consider for each slack variable yᵢ, 1≤i≤nᵢ: the upper and lower bounds when yᵢ=0 and the upper and lower bounds when yᵢ=1. For example, the “event” can be defined as “does an account have a balance greater than 1000.” The constraints are formulated to prove that yᵢ=1 corresponds to the event being triggered after the new payment is allocated and yᵢ=0 corresponds to the event not being triggered after the new payment is allocated. After the payment is allocated to an account, the new balance becomes: new_balᵢ=balᵢ−pᵢ.

In some examples, the following constraint formulation is used for the slack variable yᵢ:

balᵢ−pᵢ−1000>M₁*(1−yᵢ) (5)

M₁ is a constant to be determined by examining different cases with different values of the slack variables yᵢ. For the first case yᵢ=1, the formulation in Eq. (5) becomes balᵢ−pᵢ−1000>0, which can be rewritten as new_balᵢ=balᵢ−pᵢ>1000, which corresponds to the event being triggered after the new payment is allocated. For the second case where yᵢ=0, the formulation in Eq. (5) becomes

balᵢ−pᵢ−1000>M₁,

or

balᵢ−M₁−1000>pᵢ (6)

In this case, M₁ can be determined by imposing the upper bound ub from (4) that the payment pᵢ should be less than or equal to Uᵢ, pᵢ≤Uᵢ<Uᵢ+1. As a result, setting balᵢ−M₁−1000=Uᵢ+1 gives M₁=balᵢ−1000−Uᵢ−1=balᵢ−1001−Uᵢ. In some instances, Uᵢ=balᵢ, indicating that the payment is bounded above by the balance. In this case, M₁=−1001. Therefore, the constraint equation (5) becomes balᵢ−pᵢ−1000>−1001*(1−yᵢ) or pᵢ+1001*yᵢ≤balᵢ+1 or pᵢ+1001*yᵢ≤balᵢ for integer values of balance. This is the first set of constraints (i.e., the first nᵢ constraints out of the 2nᵢ constraints) in the A matrix of Eq. (4).

In some examples, the following constraint formulation is also used for the slack variable yᵢ:

balᵢ−pᵢ−1000≤M₂*(Yᵢ) (7)

M₂ is another constant to be determined by examining different cases with different values of the slack variables yᵢ. For the first case where yᵢ=1, the constraint formulation in Eqn. (7) becomes balᵢ−pᵢ−1000≤M₂ or balᵢ−M₂−1000≤pᵢ. By applying the lower bound constraint that the payment should be greater than Lᵢ, Eq. (7) becomes balᵢ−M₂−1000=Lᵢ which leads to M₂=balᵢ−1000−Lᵢ . In some instances, Lᵢ=0, indicating that the payment should be greater than or equal to $0. In this case, M₂=balᵢ−1000. For the second case where yᵢ=0, the formulation in Eqn. (7) becomes: balᵢ−pᵢ−1000≤0, which can be rewritten as new_balᵢ=balᵢ−pᵢ≤1000, which corresponds to the event not being triggered after the new payment is allocated. Therefore, the constraint equation (7) becomes balᵢ−pᵢ−1000≤(balᵢ−1000)*yᵢ, which can be rewritten as −pᵢ+(1000−balᵢ)*yᵢ≤1000−balᵢ. This is the second set of constraints (the last nᵢ constraints out of the 2nᵢ constraints) in the A matrix of equation (4). To summarize, the constraints to be introduced to the optimization problem are:

pᵢ+1001*yᵢ≤balᵢ

and

−pᵢ+(1000−balᵢ)*yᵢ≤1000−balᵢ, 1≤i≤nᵢ

as shown in Eq. (4), and the case when the slack variable yᵢ=0 corresponds to the event not being triggered and the case yᵢ=1 corresponds to the event being triggered after the payment pᵢ is applied to the account balance.

Other similar attributes (e.g., the number of accounts with a balance greater than $0, the number of accounts with a past due amount greater than $0, the number of accounts with utilization less than or equal to 50%) can also be formulated as slack variables with appropriate constraints. For example, if the attributes to the risk assessment proxy model 132 formulated in Eq. (3) further includes the number of accounts with a past due amount greater than 0, Σⱼ₌₁ⁿ^{ᵢ}I(pdⱼ>0), slack variables for this attribute can be introduced similarly. The slack variables can be continuous variables that have values between 0 and 1 that, when additional constraints are imposed on the model, corresponds to the event “past due amount greater than 0” being triggered (slack variable=1) or not triggered (slack variable=0) to indicate if an account has a past-due amount greater than 0. Denote the past-due amount of account i as pdᵢ, then the new past due amount after payment pᵢ becomes new_pdᵢ=pdᵢ−pᵢ. If yᵢ=1, then new constraints can be imposed that correspond to new_pdᵢ>0, the event being triggered. If yᵢ=0, new constraints can be imposed that correspond to new_pdᵢ≤0, the event not being triggered.

Again, four cases listed above are also considered and formulations new_pdᵢ=pdᵢ−pᵢ>M₁*(1−yᵢ) and new_pdᵢ=pdᵢ−pᵢ≤M₂*(yᵢ) are used to derive the constraints. Following the same procedure as described above to consider the cases yᵢ=0 and yᵢ=1 for each formulation, M₁ and M₂ can be solved and the constraints to be introduced into the optimization problem can include:

pdᵢ−pᵢ>(pdᵢ−bal₁−1)*(1−yᵢ),

and

pdᵢ−pᵢpdᵢ*(yᵢ).

These constraints can be rewritten in the form of the constraints in Eq. (4) as

pᵢ+(1+balᵢ−pdᵢ)*yᵢ≤balᵢ,

and

−pᵢ−pdᵢ*yᵢ≤pdᵢ

for integer values of balance.

In another example, if the input attributes further include the number of accounts with utilization less than or equal to 0.5, Σⱼ₌₁ⁿ^{ᵢ}1(utlⱼ≤0.5), slack variables for this attribute can be introduced and the corresponding constraints can be derived similarly. The utilization of an account can be defined as the ratio between the balance and the credit limit of the account. As such, the event in this case is

$${new\_utl}_{i} - 0.5 = \frac{b a {l}_{i} - {p}_{i}}{c {l}_{i}} - 0.5 < 0 ,$$

where clᵢ is the credit limit of account i. The formulations used here include

$$\frac{b a {l}_{i} - {p}_{i}}{c {l}_{i}} - 0.5 \leq {M}_{1} * ( 1 - {y}_{i} ) and \frac{b a {l}_{i} - {p}_{i}}{c {l}_{i}} - 0.5 > {M}_{2} * ( {y}_{i} ) .$$

M₁ and M₂ can be solved in a way similar to that discussed above, by considering the cases yᵢ=0 and yᵢ=1 for each formulation. The constraints to be introduced into the optimization problem can include:

$$\frac{b a {l}_{i} - {p}_{i}}{c {l}_{i}} - 0.5 \leq ( \frac{b a {l}_{i}}{c {l}_{i}} - 0.5 ) * ( 1 - {y}_{i} ) , and$$

$$\frac{b a {l}_{i} - {p}_{i}}{c {l}_{i}} - 0.5 > ( \frac{- 1}{c {l}_{i}} - 0.5 ) * ( {y}_{i} ) .$$

These constraints can be rewritten in the form of the constraints in Eq. (4) as

$$\frac{- 1}{c {l}_{i}} {p}_{i} + ( \frac{b a {l}_{i}}{c {l}_{i}} - 0.5 ) * {y}_{i} \leq 0 , and$$

$$\frac{1}{c {l}_{i}} {p}_{i} - ( \frac{1}{c {l}_{i}} + 0.5 ) * {y}_{i} \leq \frac{b a {l}_{i} - 1}{c {l}_{i}} - 0.5$$

for integer values of balance.

Slack variables and corresponding constraints for other variables in the optimization problem that are associated with an indicator function can be similarly introduced and derived. These slack variables and corresponding constraints are added to the optimization problem formulation. In some implementations, there are 70 payment-dependent attributes in the optimization problem. By solving this optimization problem, the optimized payment allocation plan p*=[p*₁, p*₂, p*₃, . . . , p*ₙ_{ᵢ}]^{T} that maximizes the approximated credit score S can be determined.

To illustrate solving the optimization problem for p*, we consider the example in equation (4) with three accounts n₁=3. Three slack variables yᵢ, y₂, y₃ are introduced to indicate if a particular account has a balance greater than 1000. Suppose the current balances of these accounts are bal=[1003; 1002; 1004]^{T}. The slack variables yᵢ, y₂, and y₃ each has a value between 0 and 1. A feasible solution to the linear-programming problem equation (4) is a vector x=[p₁, p₂, p₃, y₁, y₂, y₃ ]^{T} which satisfies the constraint equations A·x≤b and lb≤x≤ub specified in Eq. (4). A minimal feasible solution to Eq. (4) is a feasible solution that also minimizes the objective function min: −S in Eq. (4).

It is known that the set of all feasible solutions to the linear programming problem in Eq. (4) is a convex set. If the convex set is empty, then the problem does not have a solution. For example, if the payment resources C₁ available for allocation is less than the total scheduled payments, then Eq. (4) will not have a solution. An electronic message may be communicated to client computing systems 104 or user computing systems 106 to indicate insufficient resources to optimize the payment allocation plan.

If the convex set is not empty, then Eq. (4) has at least one minimal feasible solution x*=[p*₁, p*₂, p*₃, y*₁, y*₂, y*₃]^{T}. If the minimal feasible solution x* is unique, then the optimal payment allocation plan is p*=[p*₁, p₂, p*₃]^{T} given by the first three components of x*. If the minimal feasible solution is not unique, then there are in fact an infinite number of minimal feasible solutions, each providing the same minimum value of the objective function −S, since every convex combination of two minimal feasible solutions is also a minimal feasible solution. In this case, priority may be given to an account according to the information provided by the client computing systems 104 or user computing systems 106. For example, a consumer could indicate in the user computing systems 106 that an account has the highest interest rate among his accounts. The entity assessment server 118 could select the minimal feasible solution x* from among the infinite number of minimal feasible solutions that allocates the largest resource allocation to the account with the highest interest rate. Other criteria could be used to select a single solution from among the infinite number of minimal feasible solutions.

A numerical linear programming solver may be used to solve Eq. (4). A solver may start with a feasible solution x₀ and numerically iterate to find a minimal feasible solution x*. The input to the optimization problem, x₀, may be a feasible solution consisting of three payments of $0 and three slack variables:

x₀=[0,0,0,1,1,1]^{T};

lb=[0,0,0,0,0,0]^{T};

ub=[1003, 1002, 1004,1,1,1]^{T}.

Here, x₀ has 0's as the first three entries indicating that the payment allocation of 0 is applied towards each account at numerical iteration 0. The three 1′s indicate that the balances are greater than 1000 on each account, and they are the slack variables yᵢ, _{Y2,} y₃ introduced in this case. The first three lower bounds indicate the minimum scheduled payment for each account that may be supplied by the client computing systems 104 or user computing systems 106 or estimated by the entity assessment server 118 using risk data repository 122. In this example, the scheduled payments are $0 for each account. The final three lower bounds indicate the slack variables must be greater than or equal to 0. The first three upper bounds indicate that the payments should not exceed the current balances. The final three upper bounds indicate that the slack variables should not exceed one. The input x₀ to the numerical solver is a feasible solution. As discussed previously, Eq. (4) will either have a unique minimal feasible solution or an infinite number of minimal feasible solutions.

The minimal feasible solution x* may contain non-integer values of the slack variables y₁, y₂, and y₃, since the slack variables are continuous approximations of indicator functions in Eq. (3). The entity assessment server 118 may execute the automated optimization code 114 to round slack variables y₁, y₂, and y₃ to integer values in order that the objective function −S in Eq. (4) better approximates the attributes in the risk assessment proxy model 132. In other embodiments, additional constraints may be added to a numerical linear programming solver that allows non-linear constraints to force the slack variables to take only integer values 0 and 1. For example, quadratic constraints yᵢ* (1−yᵢ)=0 may be added to the constraints in Eq. (4). If a minimal feasible solution x* exists, then the slack variables will necessarily take only the integer values 0 and 1. In an embodiment, p* is the portion of the minimal feasible solution x* that is passed from block 306 to block 308 in FIG. 3.

Note that the optimization problem formulated in Eqs. (3) and (4) is a simplified example and should not be construed as limiting. The optimization problem formulation can be expanded to include more input attributes including payment-dependent or non-payment-dependent attributes. Further, the optimization problem can be expanded to include other factors that impact the value of the attributes after the allocation plan is executed, such as the interest on the balance of an account, the entity's monthly spending, or other expenditures. These types of information, such as the interest rate and monthly spending, can be obtained from the entity or estimated from historical data associated with the entity. Various other factors can also be incorporated into the formulation of the optimization problem for determining the payment allocation plan.

Referring back to FIG. 3, at block 308, the entity assessment server 118, or more specifically, the attribute update module 140, computes the new values of the input attributes for the risk assessment model 120 after the allocation plan is executed. In some examples, the risk assessment model 120 uses payment-dependent attributes and time-dependent attributes to predict the risk indicator for an entity. For payment-dependent attributes, the attribute update module 140 can update the values based on the allocation plan determined at block 306, i.e., new_balⱼ=balⱼ−p*ⱼ. If other information associated with the entity, such as interest rate and monthly spending, is available, the payment-dependent attributes can be updated to include that information to obtain a more accurate value of the balance field. For example, if the interest rate and the spending of an account is known, the new balance for that account becomes new_balⱼ=balⱼ(1+rateᵢₙₜₑᵣₑₛₜ)+spending−p*ⱼ.

For time-dependent attributes, the attribute update module 140 increases the time period by the time period of the payment allocation plan. In some implementations, the payment allocation plan is generated for a one-month time period. The attribute update module 140 can thus update the time-dependent attributes by increasing the time by one month. In this example, the attribute update module 140 increases the value of the attribute such as the age of the oldest account by one month. For an attribute such as the number of accounts opened in the last six months, the attribute update module 140 can query the risk data repository 122 to re-determine the attribute value for the updated time window, which includes the newly added one month and the latest five months in the previously used six-month time window. The values of other time-dependent attributes can be updated similarly.

Some attributes, however, depend on both time and payment. For example, the attribute “Number of 30 Days Past Due Occurrences within 24 Months” for an entity depends on both time (e.g., past 24 months) and payment (a number of late payments such as a number of payments that are at least 30 days late). Updating this type of attribute requires shifting the time for the accounts of the entity by one month, which removes the data of the oldest month and adds data for the current month. Further, determining the number of late payments (i.e., number of “30 days past due” occurrences) requires updating the payment information of the current month on accounts of the entity to include the allocated payment. The attribute update module 140 can utilize the updated information on the account to compute the updated attribute values.

To generalize the various examples described above, the attribute update module 140 can update the various fields of accounts associated with an entity as a function of the payment and time. Based on the updated fields, the attribute update module 140 can compute the updated attributes by aggregating across relevant fields of the accounts. The following describes several examples of the attribute update module 140 updating the attribute values based on updating the fields in the accounts associated with an entity.

Table 1 shows an example of hypothetical six-month payment history for a consumer. Each row represents an account of the consumer and each position in the grid represents the account status at a given time period. The account status (or “status” in short) is an ordinal-valued variable indicating the number of payment periods (e.g., months) that the consumer is past due. For example, status 0 means the account is current on payments, status 1 means one billing cycle past due; status 2 means two billing cycles past due, etc. A billing cycle can be, for example, one month or any other time period. In Table 1, the column with t=0 shows the current status of the accounts, the column with t=−1 shows the status of the accounts one month ago, the column with t=−2 shows the status of the accounts two months ago, etc. The table indicates that currently (t=0), this consumer is two months past due on a credit card and a car loan, and current on a mortgage. Table 1 also includes a column showing the age of the respective accounts, which is measured in terms of months from the opening of the account.

TABLE 1
Hypothetical six-month payment history grid for a consumer

| | | | | | | | | | Age of |
|---|---|---|---|---|---|---|---|---|---|
| | Account | Time Period | | | | | | | Account |
| Account | Type | t = 0 | t = −1 | t = −2 | t = −3 | t = −4 | t = −5 | t = −6 | (mos.) |
| Credit Card | Revolving | 2 | 1 | 0 | 0 | 1 | 0 | 0 | 72 |
| Car Loan | Installment | 2 | 2 | 1 | 0 | 0 | 0 | 1 | 26 |
| Mortgage | Installment | 0 | 0 | 0 | 0 | 0 | 0 | 0 | 120 |

Attributes used to predict the credit scores can be derived from the payment history. Examples of attributes derived from the grid history in Table 1 can include the age of the oldest account, which is 120 months. The attributes can also include the number of one-month past-due occurrences on the revolving accounts within six months. In this example, the number of one-month past due occurrences is “2” because the consumer was one-month past due twice over the six-month history on the revolving account. Attributes such as the number of one-month past-due occurrences on auto installment accounts within six months (2 in this example on the car loan account), the number of accounts with no past-due in the last six months (1 in this example, the mortgage account), and the number of accounts three-month past due within the past three months (0 in this example) can also be derived.

To update the attributes, the payment history based on which the attributes are updated can be updated. Table 2 shows an updated payment history based on that shown in Table 1. In Table 2, t=0 is the “new” current status after updating (in this example the consumer became current on all accounts). Time period t=−1 in Table 2 corresponds to t=0 in Table 1. Time period t=−2 in Table 2 corresponds tot=−1 in Table 1. Time period t=−6 in Table 2 corresponds to t=−5 in Table 1. The account status at t=−6 in Table 1 is absent from Table 2 because that account status is more than six months old. In Table 2, the “Age of Account” attribute is increased by one month during the update.

TABLE 2
Updating the six-month payment history grid for a consumer in Table 1.

| | | | | | | | | | Age of |
|---|---|---|---|---|---|---|---|---|---|
| | Acct. | Time Period | | | | | | | Account |
| Account | Type | t = 0 | t = −1 | t = −2 | t = −3 | t = −4 | t = −5 | t = −6 | (mos.) |
| Credit Card | Revolving | 0 | 2 | 1 | 0 | 0 | 1 | 0 | 73 |
| Car Loan | Installment | 0 | 2 | 2 | 1 | 0 | 0 | 0 | 27 |
| Mortgage | Installment | 0 | 0 | 0 | 0 | 0 | 0 | 0 | 121 |

Based on the updated payment history, attributes derived from the payment history can also be updated. For example, the above example attributes can be updated as follows. The age of the oldest account becomes 121, the number of one-month past-due occurrences on revolving accounts within six months remains 2, the number of one-month past-due occurrences on auto installment accounts within six months becomes 1, the number of accounts with no past due in the last six months and the number of accounts three-month past due within past three months remains unchanged.

In addition to the attributes derived based on the payment history, other attributes can be derived for individual accounts. For example, for revolving accounts, examples of attributes can include date reported, actual payment, balance, scheduled payment, past due amount, and status. The date reported is an indicator of time or date in months when other attributes are generated. The actual payment is the payment made to the account in the current time period, such as the payment pᵢ allocated to the account i. The scheduled payment is, for example, the minimum payment that needs to be made to the account to avoid past due. The new scheduled payment is a function of the scheduled payment amount, current balance, and new balance after updating. In some examples, the scheduled payment is a fixed percentage of the balance. The past due amount is the amount owed by the consumer whose payment is late. The status indicates the number of payment periods (e.g., months) that the consumer is past due as explained above.

After the payment is allocated to the account based on the allocation plan, these attributes can be updated. An example of an algorithm for updating these attributes is summarized in Table 3.

TABLE 3
Sample algorithm for updating attributes for a revolving account i

```
New_date_reportedᵢ = date_reportedᵢ + 1 month
New_actual_paymentᵢ =
New_balanceᵢ = old_balanceᵢ − pᵢ
New_scheduled_paymentᵢ = scheduled_paymentᵢ/balanceᵢ * new_balanceᵢ
New_past_due_amountᵢ (the past due amount still owed by the consumer after
updating)
  If (new_actual_paymentᵢ >= scheduled_paymentᵢ) then
    new_past_due_amountᵢ = max(past_due_amountᵢ −
    (new_actual_paymentᵢ − scheduled_paymentᵢ), 0)
  Else if (new_actual_paymentᵢ < scheduled_paymentᵢ) then
    new_past_due_amountᵢ = past_due_amountᵢ +
    (scheduled_paymentᵢ − new_actual_paymentᵢ)
New_statusᵢ
  If (new_actual_paymentᵢ < scheduled_paymentᵢ) then
    new_statusᵢ = statusᵢ + 1
  Else if (new_actual_paymentᵢ ≥ scheduled_paymentᵢ and statusᵢ = 0) then
    new_statusᵢ = 0
  Else if (new_actual_paymentᵢ = scheduled_paymentᵢ) then
    new_statusᵢ = old_statusᵢ
    Else new_statusᵢ = maximum(statusᵢ − FLOOR( (new_actual_paymentᵢ −
  scheduled_paymentᵢ) / (past_due_amountᵢ / statusᵢ) ) , 0)
```

The status computations are based on the assumption that the historical data is unknown and, thus, how the past due amounts accumulated is unknown. Therefore, an approximation estimate can be made that the past due amounts are evenly distributed across each of the months the account was past due.

Table 4 shows several examples of updating the attributes for a revolving account. For simplicity, this example assumes a minimum payment amount equal to 3% of the balance and excludes future spending, interest rates, and fees. In this example, the consumer is $550 past due and has a status of 2 (i.e., two billing cycles past due). According to the above assumption, the past due amount per past due month is $550/2=$275 (i.e., past due amount/status). In the example, if the consumer pays the scheduled payment and an excess payment between $0 and $274, then his status will not decrease. If he pays excess of $275 to $549, then his status will decrease by 1. If he pays excess of $550 or greater, then his status will decrease by 2. Note that the status is bounded below by 0, which is reflected in scenario (d).

TABLE 4
Example scenarios of attributes updates for a revolving account of a consumer.

| | Scenario | | | | |
|---|---|---|---|---|---|
| Attributes | Current | (a) | (b) | (c) | (d) |
| Time (month) | t = 0 | t = 1 | t = 1 | t = 1 | t = 1 |
| Balance | $15000 | $14900 | $14550 | $14250 | $14000 |
| Actual Payment | — | $100 | $450 | $450 + $300 | $450 + $550 |
| Status (months PD) | 2 | 3 | 2 | 1 | 0 |
| Past Due | $550 | $550 + | $550 | $250 | $0 |
| Amount | | ($450-$100) = | | | |
| | | $900 | | | |
| Minimum Payment | $450 | $447 | $436.5 | $427.5 | $420 |
| Amount | | | | | |

In the example shown in Table 4, the consumer has a revolving credit line with a current (t=0) balance of $15,000, is two-months past due, is $550 past due, and has a minimum payment of $450. Following the algorithm presented above in Table 3, the effects of the actual payment on the consumer's status and past due amounts for a one-month projection period can be shown under varying payment scenarios. For instance, if the consumer makes a payment below the minimum payment amount as in scenario (a), then his status now becomes -three months past due, while his past due amounts increase to $550 plus the amount of the scheduled payment not met. If the consumer makes the minimum payment amount ($450) as in scenario (b), his status remains two months past due. The consumer may also reduce his past due status by making payments exceeding the minimum payment amount, which is reflected in scenarios (c) and (d) in Table 4. In these two scenarios (c) and (d), the consumer paid the minimum payment amount and additionally paid back the missed payments which allowed him to reduce his status from two-month past due to one-month and zero-months past due, respectively.

Similar to the revolving accounts, attributes for the installment accounts can also be updated. Examples of installment trades include mortgages and car loans, whereby the monthly scheduled payment is fixed (e.g., monthly scheduled mortgage payment of $1000). In some examples, updating the attributes for the installment accounts is the same as updating the attributes for revolving accounts except that the scheduled payment attributes remain the same before and after the update. Table 5 summarizes an example of an algorithm for updating attributes for an installment account.

TABLE 5
Sample algorithm for updating attributes for an installment account i

```
New_date_reportedᵢ = date_reportedᵢ + 1 month
New_actual_paymentᵢ = pᵢ
New_balanceᵢ = old_balanceᵢ− pᵢ
New_scheduled_paymentᵢ = scheduled_paymentᵢ
New_past_due_amountᵢ (the past due amount still owed by the consumer after
updating)
  If (new_actual_paymentᵢ >= scheduled_paymentᵢ) then
    new_past_due_amountᵢ = max(past_due_amountᵢ −
    (new_actual_paymentᵢ − scheduled_paymentᵢ), 0)
  Else if (new_actual_paymentᵢ < scheduled_paymentᵢ) then
    new_past_due_amountᵢ = past_due_amountᵢ +
    (scheduled_paymentᵢ − new_actual_paymentᵢ)
New_statusᵢ
  If (new_actual_paymentᵢ < scheduled_paymentᵢ) then
    new_statusᵢ = statusᵢ + 1
  Else if (new_actual_paymentᵢ ≥ scheduled_paymentᵢ and statusᵢ = 0) then
    new_statusᵢ = 0
  Else if (new_actual_paymentᵢ = scheduled_paymentᵢ) then
    new_statusᵢ = old_statusᵢ
    Else new_statusᵢ = maximum(statusᵢ − FLOOR(
  (new_actual_paymentᵢ − scheduled_paymentᵢ) / (past_due_amountᵢ /
  statusᵢ)), 0)
```

The attributes and the associated updating algorithms described above are for illustration purposes only and should not be construed as limiting. Various other attributes can be utilized and updated in a way similar to the above examples.

At block 310, the entity assessment server 118 determines the risk indicator for the entity by employing the risk assessment model 120 based on the updated attribute values. Compared with the risk assessment proxy model 132, the risk assessment model 120 operates on more input attributes and may adopt a more complicated form (linear or non-linear) and, thus, is more accurate than the risk assessment proxy model 132 in estimating the credit score of the entity and thereby predicting the risk indicator.

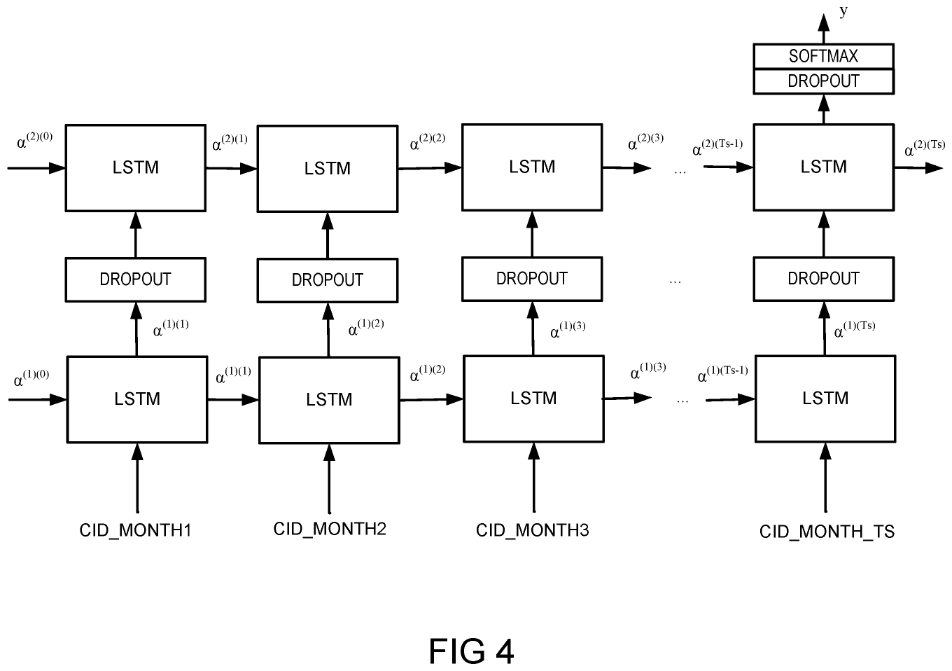

In some examples, the risk assessment model 120 employs a recurrent neural network (RNN) model trained to predict the risk indicator for an entity based on the input attribute values associated with the entity. The RNN can capture the trajectory of the entity's credit health when making the prediction. FIG. 4 shows an example of the structure of an RNN that can be employed to predict the risk indicator. Softmax is the multinomial output representing the risk indicator. In some examples, the risk indicator is a binary output representing approval or denial. In other examples, the risk indicator can be the credit score associated with the entity.

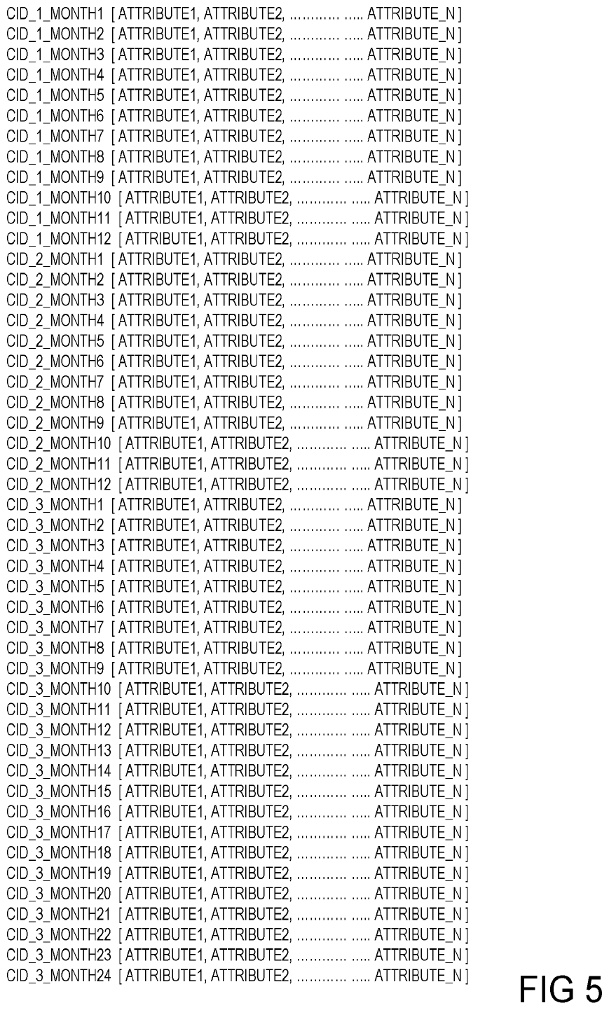

In the example shown in FIG. 4, there are two hidden layers for each neural network (“NN”) and, in total, there are Ts NNs, each representing a time-point (e.g., a month). The RNN strings together multiple NNs. In the example where a time-point represents a month, the corresponding month's attribute values for the consumer are used. FIG. 5 shows an example of the attribute values used for different consumers at different time points. For example, CID_1_MONTH1 can be a one-dimensional attribute vector of length 30 at time point 1; CID_1_MONTH2 is a one-dimensional attribute vector of length 30 at time point 2 and CID_1_MONTHTs is a one-dimensional attribute vector of length 30 at time point T_{S} for one consumer. CID_2 MONTH_1-CID_2_MONTHTs represent the attribute values for another consumer. Likewise, CID_3_MONTH1-CID_3_MONTHTs represent yet another consumer. It should be noted that labels such as “CID_1_MONTH1” and “CID_1_MONTH2” in FIG. 5 are also used to represent the keys representing the attribute values. It should also be appreciated that different consumers could have attribute values for different lengths of time. For example, the third consumer in FIG. 5 has attribute values for 24 months, whereas the first two consumers have attribute values for 12 months. In some implementations, T_{S} is set to 12 (or 24) corresponding to 12 (or 24) months.

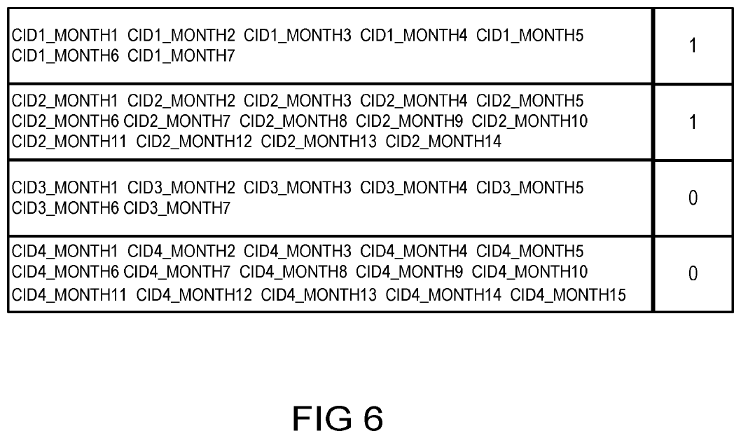

During the training of the RNN, the development server 110 accesses the risk data repository 122 to obtain training data. The training data include the attribute values for entities (e.g., consumers) having known risk indicator values. An example of the training data is shown in FIG. 6. In this example, the attribute values can be obtained through the keys. The “0” and “1” at the end of each row represent the risk indicator values associated with the respective entities given the associated attribute values, such as approved or denied. The attribute values may be obtained from the attribute data 124 and the corresponding risk indicator values may be obtained from the risk assessment data 126. In other examples, the attribute values and the risk indicator values associated with the entities are stored together. If an entity does not have attribute data for the entire T_{S} time periods, zero-padding or other similar techniques can be used to obtain the complete training data.

Depending on the training data, the risk assessment model 120 can be trained for a specific customer, such as a bank or other financial institution, based on their specific risk indicator calculation criteria. Further, by employing the RNN as the risk assessment model 120, the trajectory of the entity's credit health over the past T_{S} time periods, rather than a static credit status at the current time period, is used to predict the risk indicator. This leads to a more accurate prediction of the risk indicator for approving or disapproving the entity for a credit product, if the risk assessment model 120 is not the model used for the approve/decline decision. For example, two entities might have the same credit score of 652. However, one entity might soon be on an upward trajectory because negative information is about to roll out of the input attributes while the other one might be on a downward trajectory because of recent delinquency and potential future delinquencies that are about to incur. The RNN is able to capture the upward trajectory of the first entity as well as the downward trajectory of the second entity.

In addition to RNN, the risk assessment model 120 can use other forms of models to predict the risk indicator. For example, if the recommendation computing system 130 has access to the model used by the customer to generate the risk indicator, the risk assessment model 120 can include such a model to determine the actual value of the risk indicator after the payment allocation plan is executed, rather than to generate a prediction of the risk indicator. In other examples, the risk assessment model 120 can include a regular neural network without using the recurrent structure of the RNN. The neural network can use the values of the attributes associated with the entity for the current time period to predict the risk indicator. Other types of models can also be utilized, such as a linear regression model or a logistic regression model.

Referring back to FIG. 3, at block 312, the process 300 involves determining if the determined risk indicator reaches the target value specified in the request is achieved. If not, the entity assessment server 118 increases the time period count K by one at block 314 and repeats the operations described above with regard to blocks 304-312 for this new time period K. For the new time period, the attribute values for the previous K-1 time periods are determined based on the allocation plans determined for the respective time period. In other words, the attribute values are determined as if the allocation plans determined in previous time periods had been executed.

If, at block 312, it is determined that the target risk indicator has been reached, the entity assessment server 118 generates the recommendation for the entity. The generated recommendation includes all the payment allocation plans determined for time periods 1 to K. In this way, the entity is provided with a step-by-step plan for each time period in order to achieve the target risk indicator. An example of the recommendation can be:
To achieve your target risk indicator value, the recommendation for you is to perform the following action plan.
1) Do not apply for new credit
2) Do not miss any payments
3) Pay p₁₁ to account 1, p₂₁ to account 2 on month 1
4) Pay p₁₂ to account 1, p₂₂ to account 2 on month 2
5) Pay p₁ₜ to account 1, p₂ₜ to account 2 on month t
6) Stay current on all accounts
   The entity assessment server 118 further transmits the generated recommendation to the requesting party.

### Example of Computing Environment for Secure Resource Management

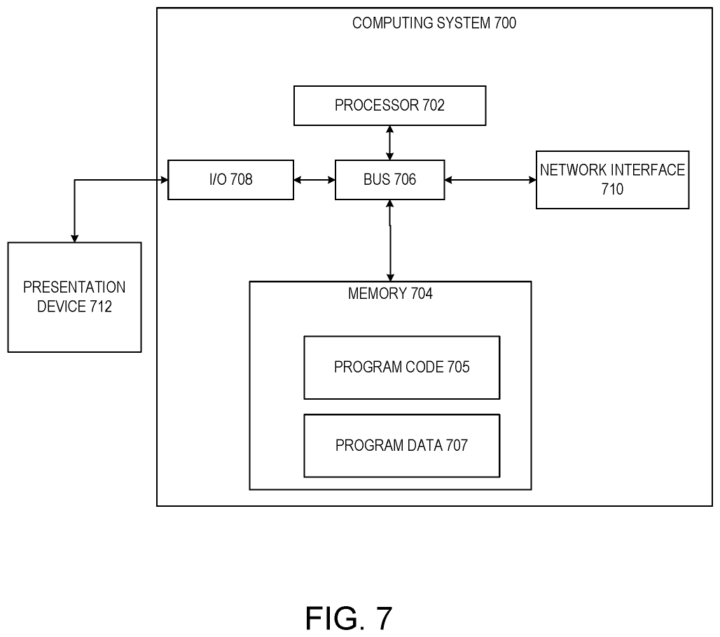

Any suitable computing system or group of computing systems can be used to perform the operations for the machine-learning operations described herein. For example, FIG. 7 is a block diagram depicting an example of a computing device 700, which can be used to implement the entity assessment server 118 or the development server 110. The computing device 700 can include various devices for communicating with other devices in the operating environment 100, as described with respect to FIG. 1. The computing device 700 can include various devices for performing one or more secure resource management operations described above with respect to FIGS. 1-6.

The computing device 700 can include a processor 702 that is communicatively coupled to a memory 704. The processor 702 executes computer-executable program code stored in the memory 704, accesses information stored in the memory 704, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 702 include a microprocessor, an application-specific integrated circuit, a field-programmable gate array, or any other suitable processing device. The processor 702 can include any number of processing devices, including one. The processor 702 can include or communicate with a memory 704. The memory 704 stores program code that, when executed by the processor 702, causes the processor to perform the operations described in this disclosure.

The memory 704 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language include Hadoop, C, C++, C#, Visual Basic, Java, Scala, Python, Perl, JavaScript, ActionScript, etc.

The computing device 700 may also include a number of external or internal devices such as input or output devices. For example, the computing device 700 is shown with an input/output interface 708 that can receive input from input devices or provide output to output devices. A bus 706 can also be included in the computing device 700. The bus 706 can communicatively couple one or more components of the computing device 700.

The computing device 700 can execute program code 705 such as the automated optimization code 114 or the model configuration application 112. The program code 705 may be resident in any suitable computer-readable medium and may be executed on any suitable processing device. For example, as depicted in FIG. 7, the program code 705 can reside in the memory 704 at the computing device 700 along with the program data 707 associated with the program code 705, such as the calculated attribute values, the resource allocation plan, or the generated recommendations. Executing the program code 705 can configure the processor 702 to perform the operations described herein.

In some aspects, the computing device 700 can include one or more output devices. One example of an output device is the network interface device 710 depicted in FIG. 7. A network interface device 710 can include any device or group of devices suitable for establishing a wired or wireless data connection to one or more data networks described herein. Non-limiting examples of the network interface device 710 include an Ethernet network adapter, a modem, etc.

Another example of an output device is the presentation device 712 depicted in FIG. 7. A presentation device 712 can include any device or group of devices suitable for providing visual, auditory, or other suitable sensory output. Non-limiting examples of the presentation device 712 include a touchscreen, a monitor, a speaker, a separate mobile computing device, etc. In some aspects, the presentation device 712 can include a remote client-computing device that communicates with the computing device 700 using one or more data networks described herein. In other aspects, the presentation device 712 can be omitted.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification that terms such as “processing,” “computing,” “determining,” and “identifying” or the like refer to actions or processes of a computing device, such as one or more computers or a similar electronic computing device or devices that manipulate or transform data represented as physical electronic or magnetic quantities within memories, registers or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computing systems accessing stored software that programs or configures the computing system from a general-purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied—for example, blocks can be re-ordered, combined, or broken into sub-blocks. Certain blocks or processes can be performed in parallel.

The use of “adapted to” or “configured to” herein is meant as an open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific aspects thereof, it will be appreciated that those skilled in the art, upon attaining an understanding of the foregoing, may readily produce alterations to, variations of, and equivalents to such aspects. Any aspects or examples may be combined with any other aspects or examples. Accordingly, it should be understood that the present disclosure has been presented for purposes of example rather than limitation and does not preclude inclusion of such modifications, variations, or additions to the present subject matter as would be readily apparent to one of ordinary skill in the art.

1. A method, in which one or more processing devices perform operations comprising:
receiving a request for a recommendation for achieving a target status of a risk indicator computed based on input attribute values for an entity;
accessing a set of input attribute values for the entity, wherein the set of input attribute values comprise resource-dependent attribute values and non-resource-dependent attribute values;
obtaining a quantity of available resource useable for modifying at least the resource-dependent attribute values;
generating a resource allocation plan for the available resource according to a first risk assessment model, wherein the resource allocation plan specifies an allocation of the available resource to resource-dependent fields of at least one account associated with the entity;
updating the set of input attribute values by updating at least the resource-dependent attribute values based on the resource allocation plan;
determining an updated value of the risk indicator for the entity based on the updated set of input attribute values according to a second risk assessment model;
generating the recommendation to include the resource allocation plan of the available resource in response to determining that the updated value of the risk indicator achieves the target status; and
transmitting, to a remote computing device, the recommendation in response to the request for the recommendation, wherein the recommendation is usable for changing the risk indicator of the entity which is used to control access to one or more interactive computing environments by the entity.

2. The method of claim 1, wherein the quantity of available resource is for a first time period, the method further comprising, in response to determining that the updated value of the risk indicator does not achieve the target status of the risk indicator:
obtaining a second quantity of available resource for a second time period useable for modifying at least the resource-dependent attribute values;
generating a second resource allocation plan of the available resource for the second time period according to the first risk assessment model;
updating the set of input attribute values by further updating resource-dependent fields of one or more accounts associated with the entity based on the second resource allocation plan;
determining a second value of the risk indicator for the entity based on the further updated set of input attribute values according to the second risk assessment model; and
generating the recommendation to include the resource allocation plan of the available resource for the first time period and the second resource allocation plan of the available resource for the second time period in response to determining that the second value of the risk indicator achieves the target status.

3. The method of claim 1, wherein the non-resource-dependent attribute values comprise time-dependent attribute values, and wherein updating the set of input attribute values further comprises updating at least one of the time-dependent attribute values.

4. The method of claim 1, wherein the first risk assessment model comprises a linear model modeling the risk indicator as a linear combination of the resource-dependent attribute values, and wherein generating the resource allocation plan of the available resource comprises determining the resource allocation plan that maximizes a value of the risk indicator.

5. The method of claim 1, wherein the second risk assessment model comprises a recurrent neural network trained to determine the updated value of the risk indicator based on a plurality of input attribute values, wherein the plurality of input attribute values comprise historical attribute values associated with the entity.

6. The method of claim 1, wherein the second risk assessment model comprises a linear regression model or a logistic regression model trained to determine the updated value of the risk indicator based on a plurality of input attribute values.

7. The method of claim 1, wherein the second risk assessment model determines the updated value of the risk indicator based on both the non-resource-dependent attribute values and resource-dependent attribute values.

8. The method of claim 1, wherein the resource-dependent attribute values comprise balance values of a plurality of accounts associated with the entity, wherein the available resource comprises monetary resource allocable to the plurality of accounts to modify at least one of the balance values.

9. The method of claim 1, wherein updating the set of input attribute values further comprises:
updating, based on the resource allocation plan, values of fields of accounts associated with the entity, the fields being resource dependent or time dependent; and
aggregating the values of the fields of the accounts to generate the updated set of input attribute values.

10. A non-transitory computer-readable storage medium having program code that is executable by a processor device to cause a computing device to perform operations, the operations comprising:
receiving a request for a recommendation for achieving a target status of a risk indicator value computed based on input attribute values for an entity;
accessing a set of input attribute values for the entity, wherein the set of input attribute values comprise resource-dependent attribute values and non-resource-dependent attribute values;
obtaining a quantity of available resource useable for modifying at least the resource-dependent attribute values;
generating a resource allocation plan for the available resource according to a first risk assessment model, wherein the resource allocation plan specifies an allocation of the available resource to resource-dependent fields of at least one account associated with the entity;
updating the set of input attribute values by updating at least the resource-dependent attribute values based on the resource allocation plan;
determining an updated value of the risk indicator for the entity based on the updated set of input attribute values according to a second risk assessment model;
generating the recommendation to include the resource allocation plan of the available resource in response to determining that the updated value of the risk indicator achieves the target status; and
causing the recommendation to be transmitted in response to the request for the recommendation.

11. The non-transitory computer-readable storage medium of claim 10, wherein updating the set of input attribute values further comprises:
updating, based on the resource allocation plan, values of fields of accounts associated with the entity, the fields being resource dependent or time dependent; and
aggregating the values of the fields of the accounts to generate the updated set of input attribute values.

12. The non-transitory computer-readable storage medium of claim 10, wherein the quantity of available resource is for a first time period, and the operations further comprise responding to determining that the updated value of the risk indicator does not achieve the target status of the risk indicator by at least:
obtaining a second quantity of available resource for a second time period useable for modifying at least the resource-dependent attribute values;
generating a second resource allocation plan of the available resource for the second time period according to the first risk assessment model;
updating the set of input attribute values by further updating resource-dependent fields of one or more accounts associated with the entity based on the second resource allocation plan;
determining a second value of the risk indicator for the entity based on the further updated set of input attribute values according to the second risk assessment model; and
generating the recommendation to include the resource allocation plan of the available resource for the first time period and the second resource allocation plan of the available resource for the second time period in response to determining that the second value of the risk indicator achieves the target status.

13. The non-transitory computer-readable storage medium of claim 10, wherein the non-resource-dependent attribute values comprise time-dependent attribute values, and wherein updating the set of input attribute values further comprises updating at least one of the time-dependent attribute values.

14. The non-transitory computer-readable storage medium of claim 10, wherein the first risk assessment model comprises a linear model modeling the risk indicator as a linear combination of the resource-dependent attribute values, and wherein generating the resource allocation plan of the available resource comprises determining the resource allocation plan that maximizes a value of the risk indicator.

15. A recommendation computing system, comprising:
a risk data repository configured for storing attribute values associated with entities; and
an entity assessment server configured to perform operations comprising:
receiving a request for a recommendation for achieving a target status of a risk indicator computed based on input attribute values for an entity;
accessing a set of input attribute values for the entity from the risk data repository, wherein the set of input attribute values comprise resource-dependent attribute values and non-resource-dependent attribute values;
obtaining a quantity of available resource useable for modifying at least the resource-dependent attribute values;
generating a resource allocation plan for the available resource according to a first risk assessment model, wherein the resource allocation plan specifies an allocation of the available resource to resource-dependent fields of at least one account associated with the entity;
updating the set of input attribute values by updating at least the resource-dependent attribute values based on the resource allocation plan;
generating the recommendation to include the resource allocation plan of the available resource; and
causing the recommendation to be transmitted in response to the request for the recommendation.

16. The recommendation computing system of claim 15, wherein the operations further comprise determining an updated value of the risk indicator for the entity based on the updated set of input attribute values according to a second risk assessment model, wherein the recommendation is generated in response to determining that the updated value of the risk indicator achieves the target status.

17. The recommendation computing system of claim 16, wherein the quantity of available resource is for a first time period and the operations further comprise in response to determining that the updated value of the risk indicator does not achieve the target status of the risk indicator,
obtaining a second quantity of available resource for a second time period useable for modifying at least the resource-dependent attribute values;
generating a second resource allocation plan of the available resource for the second time period according to the first risk assessment model;
updating the set of input attribute values by further updating resource-dependent fields of one or more accounts associated with the entity based on the second resource allocation plan;
determining a second value of the risk indicator for the entity based on the further updated set of input attribute values according to the second risk assessment model; and
generating the recommendation to include the resource allocation plan of the available resource for the first time period and the second resource allocation plan of the available resource for the second time period in response to determining that the second value of the risk indicator achieves the target status.

18. The recommendation computing system of claim 15, wherein updating the set of input attribute values further comprises:
updating, based on the resource allocation plan, values of fields of accounts associated with the entity, the fields being resource dependent or time dependent; and
aggregating the values of the fields of the accounts to generate the updated set of input attribute values.

19. The recommendation computing system of claim 15, wherein the non-resource-dependent attribute values comprise time-dependent attribute values, and wherein updating the set of input attribute values further comprises updating at least one of the time-dependent attribute values.

20. The recommendation computing system of claim 15, wherein the first risk assessment model comprises a linear model modeling the risk indicator as a linear combination of the resource-dependent attribute values, and wherein generating the resource allocation plan of the available resource comprises determining the resource allocation plan that maximizes a value of the risk indicator.
